(19) United States
(12) Patent Application Publication
(10) Pub. No.: US 2015/0379111 A1
(43) Pub. Date: Dec. 31, 2015

(54) CROWDSOURCING AUTOMATION SENSOR DATA

(71) Applicant: Vivint, Inc., Provo, UT (US)

(72) Inventor: Jungtaik Hwang, Draper, UT (US)

(21) Appl. No.: 14/316,614

(22) Filed: Jun. 26, 2014

(51) Int. Cl. G06F 17/30; H04L 29/08

(52) U.S. Cl. CPC G06F 17/30598; H04L 67/10

(57) ABSTRACT

A computer-implemented method for crowdsourcing automation sensor data is described. In one embodiment, the method includes receiving data generated by a plurality of building automation systems and categorizing each of the plurality of building automation systems. The data generated by the plurality of building automation systems includes patterns of behavior identified by each of the plurality of building automation systems. The method includes sorting each of the plurality of building automation systems by category and analyzing the data generated by the plurality of building automation systems according to the category of each building automation system.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of and continued advancements in building and residential automation, and building and residential security products and systems. For example, advancements in mobile devices allow users to monitor a home or business from anywhere in the world. Nevertheless, benefits may be realized by providing systems and methods for improving automation and security systems.

### SUMMARY

According to at least one embodiment, a computer-implemented method for crowdsourcing automation sensor data is described. In one embodiment, the method may include receiving data generated by a plurality of building automation systems and categorizing each of the plurality of building automation systems. The categories may include residential building, educational building, commercial building, industrial building, medical care building, government building, military building, agricultural building, parking and storage building, religious building, power station building, and transportation building. The data generated by the plurality of building automation systems includes patterns of behavior identified by each of the plurality of building automation systems. The method may include sorting each of the plurality of building automation systems by category and analyzing the data generated by the plurality of building automation systems according to the category of each building automation system.

In some embodiments, the method may include comparing data generated by a first building automation system of a first category with data generated by a second building automation system of the first category. In some cases, the plurality of building automation systems may include the first and second building automation systems. In some cases, the method may include identifying aggregate patterns of behavior based on the comparison of data generated by the first and second building automation systems. A range of normal behavior for the first category may be identified based on the identified aggregate patterns of behavior.

In one embodiment, the method may include receiving data generated by a third building automation system. The data generated by the third building automation system may include patterns of behavior identified by the third building automation system. The third building automation system may be categorized. In some cases, categorizing the third building automation system may include comparing the data generated by the third building automation system to aggregate patterns of behavior of one or more categories and matching the data generated by the third building automation system to aggregate patterns of behavior of at least one category.

In one embodiment, upon categorizing the third building automation system in a second category, the method may include monitoring the third building automation system in relation to aggregate patterns of behavior of the second category and, upon identifying an abnormal behavior, generating a notification. Upon categorizing the third building automation system in the second category, the identified aggregate patterns of behavior of the second category may be sent to the third building automation system to enable the third building automation system to detect abnormal behavior based on analysis of data generated by the third building automation system in relation to the aggregate patterns of behavior of the second category.

A computing device configured for crowdsourcing automation sensor data is also described. The computing device may include a processor and memory in electronic communication with the processor. The memory may store computer executable instructions that when executed by the processor cause the processor to perform the steps of receiving data generated by a plurality of building automation systems, categorizing each of the plurality of building automation systems, sorting each of the plurality of building automation systems by category, and analyzing the data generated by the plurality of building automation systems according to the category of each building automation system. The data generated by the plurality of building automation systems may include local patterns of behavior identified locally by each of the plurality of building automation systems.

A non-transitory computer-readable storage medium storing computer executable instructions is also described. When the instructions are executed by a processor, the execution of the instructions may cause the processor to perform the steps of receiving data generated by a plurality of building automation systems, categorizing each of the plurality of building automation systems, sorting each of the plurality of building automation systems by category, and analyzing the data generated by the plurality of building automation systems according to the category of each building automation system. The data generated by the plurality of building automation systems may include local patterns of behavior identified locally by each of the plurality of building automation systems.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of a device in which the present systems and methods may be implemented;

FIG. 3 is a block diagram illustrating one example of a system behavior module;

FIG. 4 is a block diagram illustrating one example of system monitoring;

FIG. 5 is a flow diagram illustrating one embodiment of a method for crowdsourcing automation sensor data;

FIG. 6 is a flow diagram illustrating one embodiment of a method for crowdsourcing automation sensor data; and

FIG. 7 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to building and residential automation and security systems. More specifically, the systems and methods described herein relate to crowdsourcing automation sensor data in relation to a building and residential automation system. Some embodiments of the systems and methods described herein relate to crowdsourcing automation sensor data in relation to an integration of building or residential automation and a messaging service.

Typical automation and security systems depend on preprogrammed sensor to detect events and notify occupants of certain conditions. Some automation and security systems may program the sensor to detect a multitude of conditions. Most automation and security systems, however, simply detect an event (e.g., motion, door open/close, temperature change, etc.) without any additional logic of what the one or more events may indicate. Accordingly, the present systems and methods analyze the patterns of data generated by multiple automation and security systems in order to detect abnormal behavior. For example, automation and security systems of homes may be analyzed to detect normal behavior within a typical home. Likewise, automation and security systems in elementary schools may be analyzed to detect normal behavior within a typical elementary school, and so forth. Accordingly, the patterns learned from the collection of residential systems may be used to monitor a residential system and detect abnormal behavior. Accordingly, in addition to the typical alerts indicating a sensor was tripped, the present systems and methods may also indicate the detection of abnormal behavior.

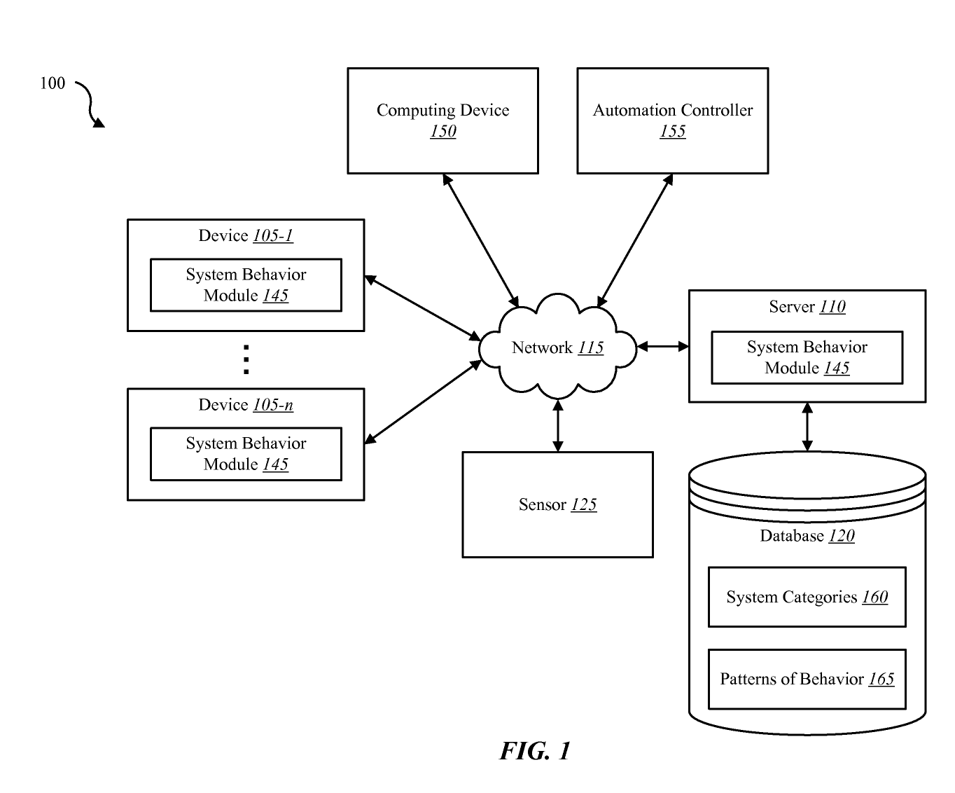

FIG. 1 is a block diagram illustrating one embodiment of an environment 100 in which the present systems and methods may be implemented. In some embodiments, the systems and methods described herein may be performed on a device (e.g., device 105). As depicted, the environment 100 may include device 105-1 to 105-n, server 110, a sensor 125, a computing device 150, an automation controller 155, and a network 115 that allows the device 105, the server 110, the computing device 150, automation controller 155, and sensor 125 to communicate with one another.

Examples of the device 105 may include any combination of mobile devices, smart phones, personal computing devices, computers, laptops, desktops, servers, a media content set top box, satellite set top box, cable set top box, DVRs, personal video recorders (PVRs), etc. In some cases, at least one of the devices 105 may include a building automation controller. Examples of automation controller 155 may include any device configured to control a building such as a home, a business, a government facility, etc. Accordingly, examples of automation controller 155 include any combination of a dedicated building automation computing device (e.g., wall-mounted controller), a personal computing device (e.g., laptop, desktop, etc.), a mobile computing device (e.g., tablet computing device, smartphone, etc.), and the like. Examples of computing device 150 may include any combination of a mobile computing device, a laptop, a desktop, a server, a media set top box, etc. Examples of server 110 may include any combination of a data server, a cloud server, a server associated with a building automation service provider, proxy server, mail server, web server, application server, database server, communications server, file server, home server, mobile server, name server, etc.

Examples of sensor 125 may include any combination of a camera sensor, audio sensor, forced entry sensor, shock sensor, proximity sensor, boundary sensor, light beam sensor, three-dimensional (3-D) sensor, motion sensor, smoke sensor, glass break sensor, door sensor, window sensor, carbon monoxide sensor, accelerometer, global positioning system (GPS) sensor, Wi-Fi positioning system sensor, capacitance sensor, radio frequency sensor, near-field sensor, temperature sensor, heartbeat sensor, breathing sensor, oxygen sensor, carbon dioxide sensor, brain wave sensor, movement sensor, voice sensor, other types of sensors, actuators, or combinations thereof. Sensor 125 may represent one or more separate sensors or a combination of two or more sensors in a single device. For example, sensor 125 may represent one or more camera sensors and one or more motion sensors connected to environment 100. Sensor 125 may be integrated with an identity detection system such as a facial recognition system and/or a voice recognition system. Although sensor 125 is depicted as connecting to device 105 over network 115, in some embodiments, sensor 125 may connect directly to or within device 105.

Additionally, or alternatively, sensor 125 may be integrated with a home appliance or fixture such as a light bulb fixture. Sensor 125 may include an accelerometer to enable sensor 125 to detect a movement. For example, sensor 125 may be carried by an occupant. Sensor 125 may include a wireless communication sensor 125 configured to send and receive data and/or information to and from one or more devices in environment 100. Additionally, or alternatively, sensor 125 may include a GPS sensor to enable sensor 125 to track a location of sensor 125 attached to an occupant and/or a device. Sensor 125 may include a proximity sensor to enable sensor to detect a proximity of a person relative to an object to which the sensor is attached and/or associated. In some embodiments, sensor 125 may include a forced entry sensor (e.g., shock sensor, glass break sensor, etc.) to enable sensor 125 to detect an attempt to enter an area by force. Sensor 125 may include a siren to emit one or more frequencies of sound (e.g., an alarm).

In some embodiments, device 105 may communicate with server 110 via network 115. Example of networks 115 may include any combination of cloud networks, local area networks (LAN), wide area networks (WAN), virtual private networks (VPN), wireless networks (using 802.11, for example), cellular networks (using 3G and/or LTE, for example), etc. In some configurations, the network 115 may include the Internet.

In some embodiments, server 110 may be coupled to database 120. Database 120 may include system categories 160 and patterns of behavior 165. Any one of devices 105 may access system categories 160 in database 120 over network 115 via server 110. System categories 160 may include categories for a residential building, educational building, commercial building, industrial building, medical care building, government building, military building, agricultural building, parking and storage building, religious building, power station building, transportation building, and the like. Patterns of behavior 165 may include patterns of behavior identified by at least one of devices 105. For example, a residential automation system may detect patterns of behavior locally within the residential automation system. Additionally, or alternatively, patterns of behavior 165 may include an aggregate patterns of behavior identified by analysis of the data generated by multiple automation systems. For example, the patterns of behavior identified locally by multiple residential systems may be analyzed to identify aggregate patterns of behavior for a typical residence. Database 120 may be internal or external to the server 110. In one example, device 105 may be coupled directly to database 120, database 120 being internal or external to device 105.

As depicted, any one of devices 105 and/or server 110 may include a system behavior module 145, where at least a portion of the functions of system behavior module 145 are performed separately and/or concurrently on device 105, automation controller 155, and/or server 110. Likewise, in some embodiments, a user may access the functions of device 105 and/or automation controller 155 (directly or through a device 105 via system behavior module 145) from computing device 150. For example, in some embodiments, computing device 150 includes a mobile application that interfaces with one or more functions of device 105, automation controller 155, system behavior module 145, and/or server 110. System behavior module 145 may enable a user to receive notifications regarding abnormal behaviors detected in relation to an automation system. Further details regarding the system behavior module 145 are discussed below.

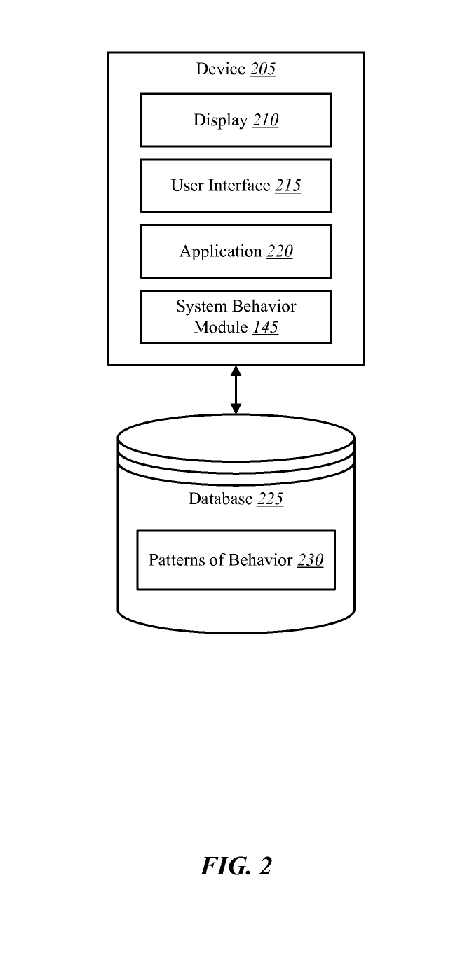

FIG. 2 is a block diagram illustrating one example of device 205. Device 205 may be one example of any one of devices 105-1 through 105-n. As depicted, device 205 may include a display 210, a user interface 215, an application 220, and system behavior module 145. Although the components of the device 105 are depicted as being internal to the device 105, it is understood that one or more of the components may be external to the device 105 and connect to device 105 through wired and/or wireless connections (e.g., network 115, etc.). In some embodiments, application 220 may be installed on computing device 150 in order to allow a user to interface with a function of device 105, system behavior module 145, automation controller 155, and/or server 110. It is noted that in some embodiments, the device 205 may not include a system behavior module 145. For example, device 205 may include application 220 that allows device 205 to interface with automation controller 155 via system behavior module 145 located on another device such as another device 105, computing device 150 and/or server 110. In some configurations, application 220 may enable device 205 to interface with automation controller 155 via system behavior module 145 to provide access to notification information to device 105 and/or computing device 150. Thus, application 220, via the system behavior module 145, may allow users to receive notifications regarding an automation system. In some cases, notifications may be displayed on display 210.

In some embodiments, device 205 may be coupled to a database 225. Database 225 may include patterns of behavior 230. Patterns of behavior 230 may include patterns of behavior identified locally by an automation system. Additionally, or alternatively, patterns of behavior 230 may include aggregate patterns of behavior identified via the analysis of several patterns of behavior collected from multiple automation systems. In some cases, patterns of behavior 230 may include information regarding patterns of behavior detected by system behavior module 145. Database 225 may be internal or external to the device 205. In one example, device 205 may be coupled directly to database 225, database 225 being internal or external to device 205.

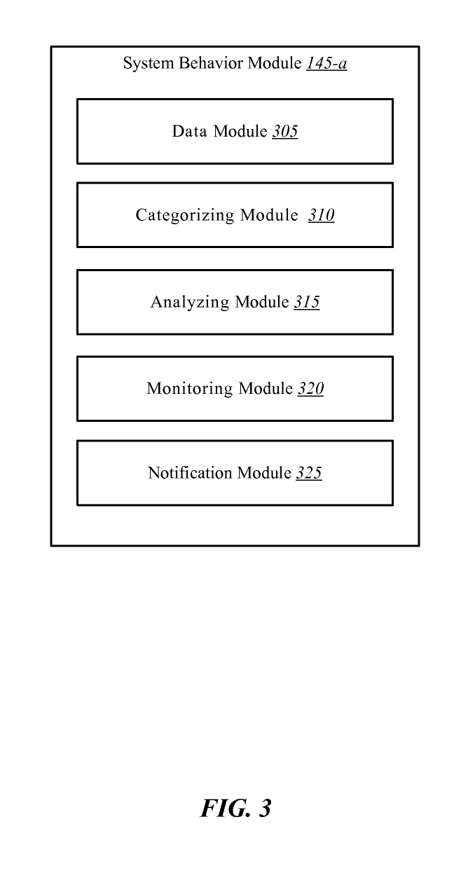

FIG. 3 is a block diagram illustrating one example of a system behavior module 145-a. System behavior module 145-a may be one example of system behavior module 145 depicted in FIG. 1. As depicted, system behavior module 145-a may include a data module 305, a categorizing module 310, a analyzing module 315, a monitoring module 320, and an notification module 325.

In one embodiment, data module 305 may receive data generated by a plurality of building automation systems. The data generated by the plurality of building automation systems may include patterns of behavior identified by each of the plurality of building automation systems. For example, a building automation system may include an automation control panel and multiple system components. The control panel may collect data generated by the system components such as detected motion, captured images, door and windows opening, and the like. The automation system may analyze the data generated by the system components and identify patterns of behavior from the analysis. The automation system may send the data generated by the system components to a backend.

In one embodiment, categorizing module 310 may categorize each of the plurality of building automation systems. Building automation systems may be installed in any number of building types. Thus, categories may include residential building, educational building, commercial building, industrial building, medical care building, government building, military building, agricultural building, parking and storage building, religious building, power station building, transportation building, and the like. In one embodiment, a system may be categorized by an installer. When an automation system is installed at a school, the type of building being monitored may be entered in the monitoring system. In some cases, categorizing module 310 may determine a category for an automation system based on patterns of behavior identified from previously categorized systems, based on hash functions, based on learning algorithms, etc.

In some cases, categorizing module 310 may sort each of the plurality of building automation systems by category. For example, categorizing module 310 may sort all residential building systems into one group of systems, educational building systems into another group of systems, and so forth.

In one embodiment, analyzing module 315 may analyze the data generated by the plurality of building automation systems according to the category of each building automation system. Thus, analyzing module 315 may analyze the group of residential building systems separately from the group of educational building systems, and so forth. In some cases, analyzing module 315 may compare data generated by a first building automation system of a first category with data generated by a second building automation system of the first category. Thus, analyzing module 315 may compare data generated by a first residential automation system with data generated by a second residential automation system. Accordingly, analyzing module 315 may identify aggregate patterns of behavior based on the comparison of data generated by the first and second building automation systems. Each type of system from the categories listed above may generate different types of data. A residential system typically does not generate data similar to a commercial system, for instance. Thus, analyzing module 315 may identify aggregate patterns of behavior based on the data from residential systems, identify aggregate patterns of behavior based on the data from commercial systems, and so forth. Analyzing module 315 may identify a range of normal behavior for each category based on the identified aggregate patterns of behavior of each system type. Thus, a range of normal behavior for a typical residence may be identified from the collection of residential systems, and a range of normal behavior for a typical commercial location may be identified from the collection of commercial systems.

In one embodiment, data module 305 may receive data generated by a new building automation system, the data generated by the new building automation system may include patterns of behavior identified by the new building automation system. Categorizing module 310 may categorize the new building automation system based on the categories listed above. In some cases, categorizing and/or analyzing the new building automation system may include comparing and matching data generated by one or more building automation systems to aggregate patterns of behavior of one or more categories. Thus, in some embodiments, analyzing module 315 may compare the data generated by the new building automation system to aggregate patterns of behavior of one or more categories. In some cases, analyzing module 315 may match the data generated by the new building automation system to aggregate patterns of behavior of at least one category. For example, upon matching the new building automation system to aggregate patterns of behavior of residential systems, the categorizing module 310 may categorize the new building automation system as a residential system.

Upon categorizing the new building automation system in the residential building category, data module 305 may send the identified aggregate patterns of behavior of the residential building category to the new building automation system to enable the new building automation system to detect abnormal behavior based on the identified aggregate patterns of behavior of the residential building category. Monitoring module 320 may monitor the new building automation system based on aggregate patterns of behavior of the residential building category. Accordingly, monitoring module 320 may monitor the new building automation system to determine whether the data generated by the new building automation system falls within the range of normal behavior for residential systems. Thus, monitoring module 320 may identify abnormal behavior from the data generated by the new building automation system. Upon identifying abnormal behavior from the new building automation system, notification module 325 may generate a notification. In some cases, the server 110 may generate a notification in conjunction with system behavior module 145-a. Additionally, or alternatively, an automation system (e.g., device 105-1, device 105-n, automation controller 155, etc.) may generate a notification in conjunction with system behavior module 145-a.

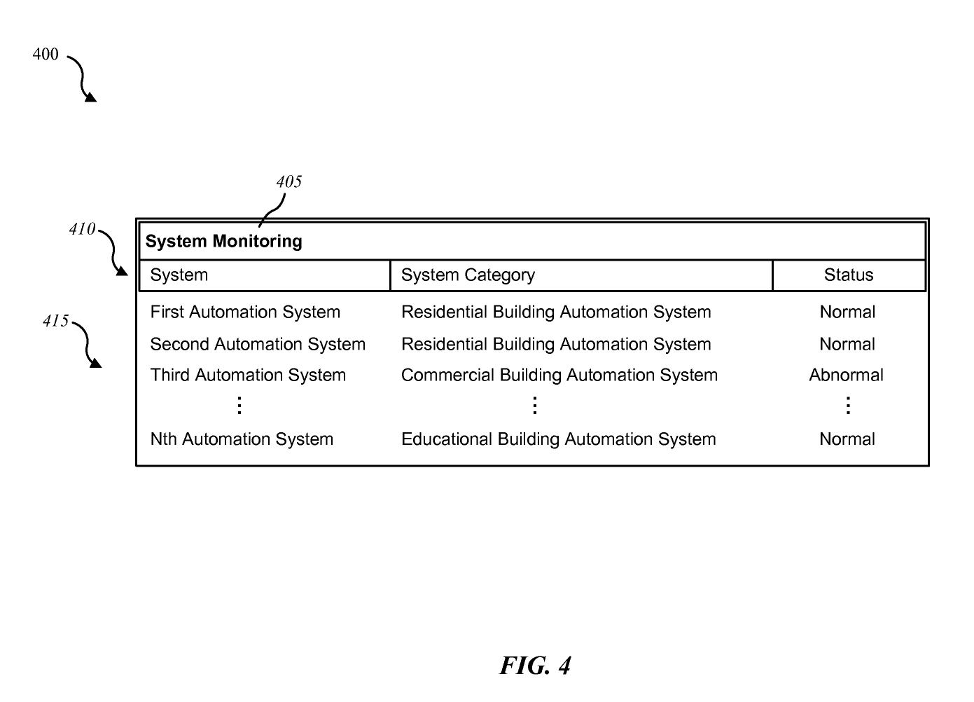

FIG. 4 is a block diagram illustrating one example of system monitoring 400 based on monitoring several automation systems. System monitoring 400 may be based on the patterns of behavior 165 depicted in FIG. 1 and/or patterns of behavior 230 depicted in FIG. 2. Additionally, or alternatively, system monitoring 400 may be based on the data collected and analyzed by system behavior module 145-a of FIG. 3.

As depicted, system monitoring 400 may provide graphical feedback regarding monitored systems. System monitoring 400 may be configured with a title bar 405 indicating that the data displayed includes “System Monitoring.” The data may be sorted and organized according to display headers 410. As illustrated, system monitoring 400 may include data entries 415 for residential, commercial, educational building automation systems, and the like. Additionally, system monitoring 400 may indicate the status of one or more automation system. Based on analysis of a particular system in relation to the aggregate patterns of behavior for that type of system, system monitoring 400 may indicate that the status of an automation system is within a “normal” range. Likewise, system monitoring 400 may indicate that the status of an automation system is outside normal range, that a particular system is in an “abnormal” range, as illustrated.

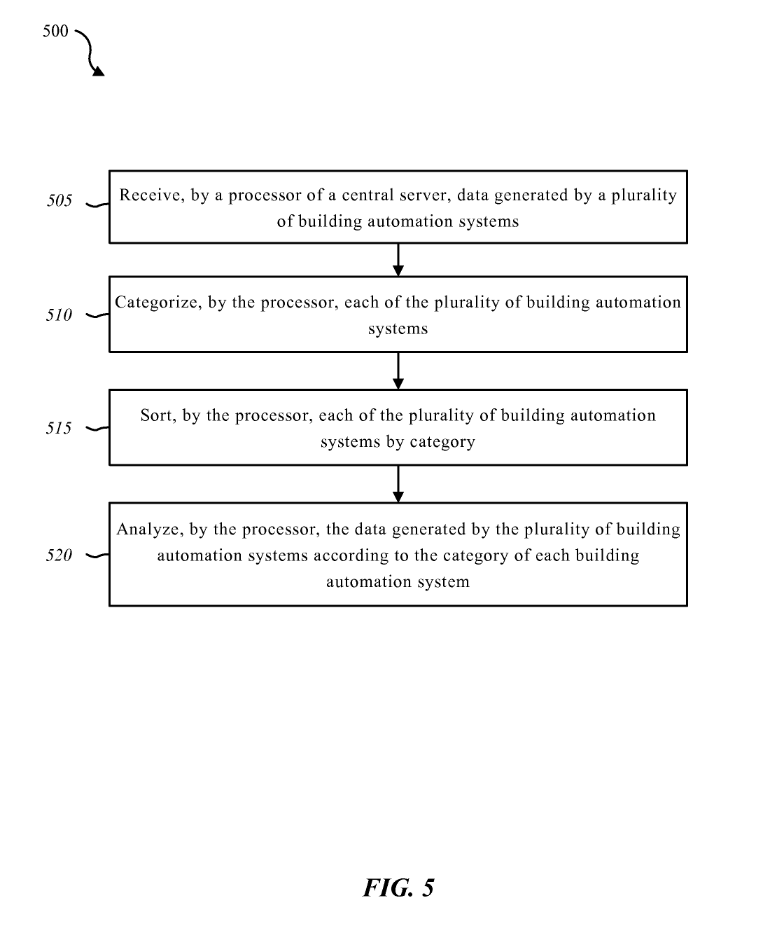

FIG. 5 is a flow diagram illustrating one embodiment of a method 500 for crowdsourcing automation sensor data. In some configurations, the method 500 may be implemented by the system behavior module 145 illustrated in FIGS. 1, 2, and/or 3. In some configurations, the method 500 may be implemented in conjunction with the application 220 and/or the user interface 215 illustrated in FIG. 2.

At block 505, data generated by a plurality of building automation systems may be received by a processor of a central server. The data generated by the plurality of building automation systems may include patterns of behavior identified by each of the plurality of building automation systems. At block 510, each of the plurality of building automation systems may be categorized. Categories may include residential building systems, educational building systems, commercial building systems, industrial building systems, medical care building systems, government building systems, military building systems, agricultural building systems, parking and storage building systems, religious building systems, power station building systems, and transportation building systems. At block 515, each of the plurality of building automation systems may be sorted by category. At block 520, the data generated by the plurality of building automation systems may be analyzed according to the category of each building automation system.

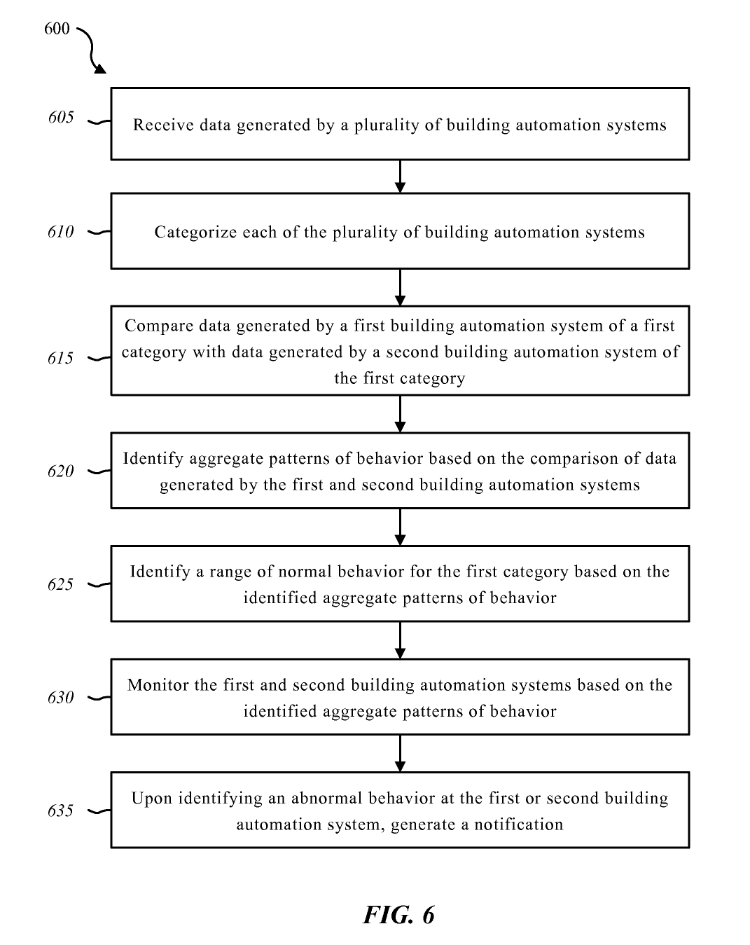

FIG. 6 is a flow diagram illustrating one embodiment of a method 600 for crowdsourcing automation sensor data. In some configurations, the method 600 may be implemented by the system behavior module 145 illustrated in FIGS. 1, 2, and/or 3. In some configurations, the method 600 may be implemented in conjunction with the application 220 and/or the user interface 215 illustrated in FIG. 2.

At block 605, data generated by a plurality of building automation systems may be received. In some cases, the data may be received and processed by a processor of a central server. At block 610, each of the plurality of building automation systems may be categorized. At block 615, data generated by a first building automation system of a first category may be compared with data generated by a second building automation system of the first category. In some cases, the plurality of building automation systems may include the first and second building automation systems. At block 620, aggregate patterns of behavior may be identified based on the comparison of data generated by the first and second building automation systems. At block 625, a range of normal behavior for the first category may be identified based on the identified aggregate patterns of behavior. At block 630, the first and second building automation systems may be monitored based on the identified aggregate patterns of behavior. At block 635, upon identifying an abnormal behavior at the first or second building automation system, a notification may be generated

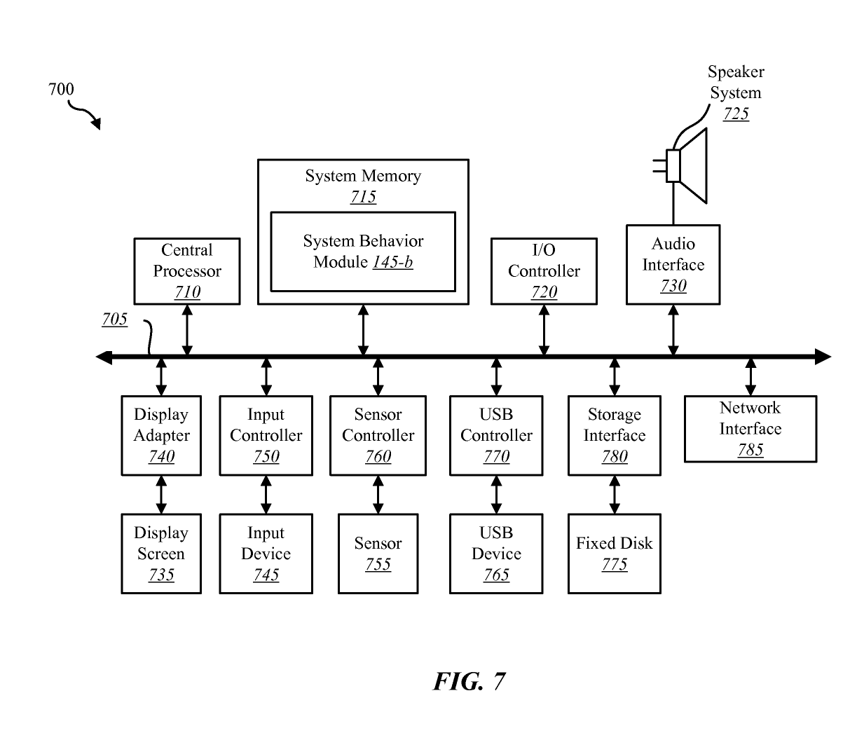

FIG. 7 depicts a block diagram of a controller 700 suitable for implementing the present systems and methods. The controller 700 may be an example of device 105, computing device 150, and/or automation controller 155 illustrated in FIG. 1. In one configuration, controller 700 includes a bus 705 which interconnects major subsystems of controller 700, such as a central processor 710, a system memory 715 (typically RAM, but which may also include ROM, flash RAM, or the like), an input/output controller 720, an external audio device, such as a speaker system 725 via an audio output interface 730, an external device, such as a display screen 735 via display adapter 740, an input device 745 (e.g., remote control device interfaced with an input controller 750), multiple USB devices 765 (interfaced with a USB controller 770), and a storage interface 780. Also included are at least one sensor 755 connected to bus 705 through a sensor controller 760 and a network interface 785 (coupled directly to bus 705).

Bus 705 allows data communication between central processor 710 and system memory 715, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the system behavior module 145-b to implement the present systems and methods may be stored within the system memory 715. Applications (e.g., application 220) resident with controller 700 are generally stored on and accessed via a non-transitory computer readable medium, such as a hard disk drive (e.g., fixed disk 775) or other storage medium. Additionally, applications can be in the form of electronic signals modulated in accordance with the application and data communication technology when accessed via interface 785.

Storage interface 780, as with the other storage interfaces of controller 700, can connect to a standard computer readable medium for storage and/or retrieval of information, such as a fixed disk drive 775. Fixed disk drive 775 may be a part of controller 700 or may be separate and accessed through other interface systems. Network interface 785 may provide a direct connection to a remote server via a direct network link to the Internet via a POP (point of presence). Network interface 785 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 700 wirelessly via network interface 785.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 7 need not be present to practice the present systems and methods. The devices and subsystems can be interconnected in different ways from that shown in FIG. 7. The aspect of some operations of a system such as that shown in FIG. 7 are readily known in the art and are not discussed in detail in this application. Code to implement the present disclosure can be stored in a non-transitory computer-readable medium such as one or more of system memory 715 or fixed disk 775. The operating system provided on controller 700 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for crowdsourcing automation system data, comprising:
receiving, by a processor of a central server, data generated by a plurality of building automation systems, the data generated by the plurality of building automation systems comprising local patterns of behavior identified locally by each of the plurality of building automation systems;
categorizing, by the processor, each of the plurality of building automation systems;
sorting, by the processor, each of the plurality of building automation systems by category; and
analyzing, by the processor, the data generated by the plurality of building automation systems according to the category of each building automation system.

2. The method of claim 1, wherein categories include residential building, educational building, commercial building, industrial building, medical care building, government building, military building, agricultural building, parking and storage building, religious building, power station building, and transportation building.

3. The method of claim 1, further comprising:
comparing, by the processor, data generated by a first building automation system of a first category with data generated by a second building automation system of the first category, wherein the plurality of building automation systems comprises the first and second building automation systems.

4. The method of claim 3, further comprising:
identifying, by the processor, aggregate patterns of behavior based on the comparison of data generated by the first and second building automation systems.

5. The method of claim 4, further comprising:
identifying, by the processor, a range of normal behavior for the first category based on the identified aggregate patterns of behavior.

6. The method of claim 1, further comprising:
receiving, by the processor, data generated by a third building automation system, the data generated by the third building automation system comprising patterns of behavior identified by the third building automation system.

7. The method of claim 6, further comprising:
categorizing, by the processor, the third building automation system.

8. The method of claim 7, wherein categorizing the third building automation system comprises:
comparing the data generated by the third building automation system to aggregate patterns of behavior of one or more categories; and
matching the data generated by the third building automation system to aggregate patterns of behavior of at least one category.

9. The method of claim 7, further comprising:
upon categorizing the third building automation system in a second category, monitoring the third building automation system in relation to aggregate patterns of behavior of the second category; and
upon identifying an abnormal behavior, generating a notification.

10. The method of claim 9, further comprising:
upon categorizing the third building automation system in the second category, sending the identified aggregate patterns of behavior of the second category to the third building automation system to enable the third building automation system to detect the abnormal behavior based on analysis of data generated by the third building automation system in relation to the aggregate patterns of behavior of the second category.

11. A computing device configured for crowdsourcing automation system data, comprising:
a processor;
memory in electronic communication with the processor, wherein the memory stores computer executable instructions that when executed by the processor cause the processor to perform the steps of:
receiving data generated by a plurality of building automation systems, the data generated by the plurality of building automation systems comprising patterns of behavior identified by each of the plurality of building automation systems;
categorizing each of the plurality of building automation systems;
sorting each of the plurality of building automation systems by category; and
analyzing the data generated by the plurality of building automation systems according to the category of each building automation system.

12. The computing device of claim 11, wherein categories include residential building, educational building, commercial building, industrial building, medical care building, government building, military building, agricultural building, parking and storage building, religious building, power station building, and transportation building.

13. The computing device of claim 11, wherein the instructions executed by the processor cause the processor to perform the steps of:
comparing data generated by a first building automation system of a first category with data generated by a second building automation system of the first category, wherein the plurality of building automation systems comprises the first and second building automation systems.

14. The computing device of claim 13, wherein the instructions executed by the processor cause the processor to perform the steps of:
identifying, by the processor, aggregate patterns of behavior based on the comparison of data generated by the first and second building automation systems.

15. The computing device of claim 14, wherein the instructions executed by the processor cause the processor to perform the steps of:
identifying a range of normal behavior for the first category based on the identified aggregate patterns of behavior.

16. The computing device of claim 11, wherein the instructions executed by the processor cause the processor to perform the steps of:
receiving data generated by a third building automation system, the data generated by the third building automation system comprising patterns of behavior identified by the third building automation system.

17. The computing device of claim 16, wherein the instructions executed by the processor cause the processor to perform the steps of:
categorizing the third building automation system.

18. The computing device of claim 17, wherein the instructions executed by the processor cause the processor to perform the steps of:
upon categorizing the third building automation system in a second category, monitoring the third building automation system in relation to aggregate patterns of behavior of the second category; and
upon identifying an abnormal behavior, generating a notification.

19. A non-transitory computer-readable storage medium storing computer executable instructions that when executed by a processor cause the processor to perform the steps of:
receiving data generated by a plurality of building automation systems, the data generated by the plurality of building automation systems comprising patterns of behavior identified by each of the plurality of building automation systems;
categorizing each of the plurality of building automation systems;
sorting each of the plurality of building automation systems by category; and
analyzing the data generated by the plurality of building automation systems according to the category of each building automation system.

20. The computer-program product of claim 19, wherein categories include residential building, educational building, commercial building, industrial building, medical care building, government building, military building, agricultural building, parking and storage building, religious building, power station building, and transportation building.
